(19) United States
(12) Patent Application Publication
(10) Pub. No.: US 2002/0099635 A1
(43) Pub. Date: Jul. 25, 2002

(54) Control of account utilization

(76) Inventor: Jack Guiragosian, Glendale, CA (US)

Correspondence Address: Anna M. Vradenburgh, Brull, Piccionelli, Sarno, Braun & Vradenburgh, Suite 2350, 1925 Century Park East, Los Angeles, CA, 90067, US

(21) Appl. No.: 10/056,733

(22) Filed: Jan. 23, 2002

Related U.S. Application Data
(60) Provisional application No. 60/263,950, filed on Jan. 24, 2001.

(51) Int. Cl. G06F 17/60

(52) U.S. Cl. 705/35

(57) ABSTRACT

Embodiments of the present invention are directed to a system, method and apparatus for controlling utilization of an account having associated therewith an issuer, a primary transaction cardholder and a secondary transaction cardholder. In preferred embodiments, the secondary transaction cardholder is associated with at least one code, wherein the code identifies a condition of account use and is provided to the issuer. Once the code is associated with the secondary cardholder, the secondary cardholder is enabled to utilize the account. When the secondary cardholder utilizes the account, the codes associated with the secondary cardholder are compared to those provided to the issuer. The transaction is allowed in accordance with the condition set by the code.

This application is based on U.S. Provisional Application Serial No. 60/263,950, filed Jan. 24, 2001, which is incorporated herein in its entirety by reference.

### BACKGROUND OF THE INVENTION

1. Field of the Invention

The present invention relates in broadest terms to methods for controlling utilization of an account, such as a credit or debit account, and in particular an account that is associated with an issuer, a primary transaction cardholder and a secondary transaction cardholder. More specifically, the present invention relates to a system for authorizing monetary transactions for the procurement of goods, services or distribution of currency using a credit or debit transaction card, and more particularly for control of spending by a secondary transaction cardholder using a secondary transaction card associated with the account of the primary transaction cardholder by which transactions are limited to merchants associated with specific merchant category codes, or restricted from being made with merchants associated with specific merchant category codes. The present invention also more particularly relates to a system for limiting the access by a secondary transaction cardholder to information associated with the account, such as credit card information.

2. Description of Related Art

There presently exist a number of credit or debit transaction card networks issuing particular types of transaction cards to their customers. For example, credit cards such as Visa or MasterCard are well known. In order to authorize a transaction, a merchant will typically contact the issuer of the card in order to receive authorization to apply the cost of the transaction to the customer's account with the issuer.

When a holder of a credit or debit transaction card presents the card to a merchant in order to procure goods, services or the distribution of currency (e.g., a cash advance from a credit card account, or an ATM withdrawal linked to the transaction card), some form of authorization by the card issuer is typically sought by the merchant to minimize theft and risk of loss to the merchant. In one early method of transaction card authorization, the merchant consulted a list of account numbers published by the card issuer or other transaction card institution, e.g., Visa or Mastercard. The merchant would check the account number of the presented card against the numbers on the list. If the account number of the transaction card appeared on the list, the merchant could refuse the transaction or telephone the appropriate card issuer for further information or instructions.

More recently, electronic transaction card authorization networks have been developed. In these networks, the merchant uses a terminal which reads account information encoded on a magnetic strip located on the back of the transaction card. The terminal then automatically calls a central processor, operated by the network, which analyzes the authorization request. The call from the terminal is typically routed through a local financial institution or transaction card issuer. The central processor, upon receipt of the call from the merchant, initiates an electronic data link to a processor operated by the transaction card issuer to determine if the transaction should be approved or refused. The processor at the transaction card issuer determines the status of the account within its database, and generates a response. This response is then routed back to the merchant's terminal, typically in the form of an approval code or refusal code.

Many transaction card issuers issue additional, or secondary, transaction cards under the account of a primary transaction cardholder (i.e., the account holder) for use by persons, other than the account holder, who are authorized by the account holder. For example, a secondary transaction card may be issued to a spouse, child, or other dependent relative of the primary transaction cardholder. Secondary transaction cards are also used by businesses, where employees use transaction cards associated with the account of the business. When a merchant seeks approval of a presented transaction card, the information accessed by the authorization networks is generally limited to the primary cardholder's account information. Spending limits on the secondary transaction cards from the primary transaction cardholder's account may or may not be lower than the primary transaction cardholder's maximum limit.

A secondary transaction cardholder may have a predetermined spending limit lower than the maximum authorized for the primary transaction cardholder. When a secondary transaction cardholder presents the transaction card to a merchant for procurement of goods, services or the distribution of currency, if the predetermined spending limit is exceeded, a refusal code will be supplied by the central processor to the merchant. Only the primary transaction cardholder may authorize an increased spending limit for a secondary transaction cardholder. Such approval for increased spending limits for secondary cardholders is typically performed by sending a letter to the card issuer, or by contacting the card issuer via telephone, at which point security identification and authentication steps must be followed. In this manner, a secondary cardholder cannot receive authorization to complete the procurement of goods, services or the distribution of currency in a timely manner.

In addition to providing a preset spending limit for a secondary transaction cardholder, a primary transaction cardholder may desire to control the usage of a secondary transaction card in other ways. For example, the primary transaction cardholder may desire to permit a secondary transaction cardholder to enter into a transaction with a merchant only if the merchant is engaged in specific types of business, or to prevent the secondary transaction cardholder from entering into a transaction with a merchant if the merchant is engaged in other specific types of business.

The primary transaction cardholder may further desire to permit a secondary transaction cardholder to access certain information pertaining to the account. Such information typically includes transaction history, available credit, statement reprints and spending reports of various types. Such information presently can be accessed, for example, via sites belonging to various credit card issuers that are found on networks such as the World Wide Web or the Internet. However, the primary transaction cardholder may desire to permit the secondary transaction cardholder to access account information pertaining to transactions made using the secondary transaction card, but to restrict the secondary transaction cardholder's access only to such account information.

A need exists for a method for controlling utilization of an account, such as a credit or debit card account, that enables a primary transaction cardholder to permit a secondary transaction cardholder to enter into transactions with merchants who are engaged in specific types of business, or to prevent the secondary transaction cardholder from entering into such transactions.

A need also exists for a method for controlling utilization of an account that enables the primary transaction cardholder to permit a secondary transaction cardholder to access account information restricted to that which pertains to transactions made using the secondary transaction card.

### SUMMARY OF THE INVENTION

In accordance with one aspect of the present invention, there is provided a method for controlling utilization of an account having associated therewith an issuer, a primary transaction cardholder and a secondary transaction cardholder. The method includes the steps of associating with the secondary transaction cardholder a code or a list of codes provided to the issuer by the primary transaction cardholder and enabling a secondary transaction cardholder to utilize the account.

In a preferred embodiment, the code is a merchant category code, or a list of merchant codes, for example, a merchant category code selected by the primary transaction cardholder from a list of merchant category codes prepared by the issuer of the account. If a merchant's code is associated with the secondary cardholder, the secondary transaction cardholder is restricted from completing a transaction with a merchant associated with the merchant category code.

### BRIEF DESCRIPTION OF THE DRAWINGS

The detailed description of embodiment of the invention will be made with reference to the accompanying drawings, wherein the numerals designate corresponding parts in the figures.

FIG. 1 is a flowchart illustrating a method for controlling account utilization in a preferred embodiment of the invention.

### DETAILED DESCRIPTION OF THE PREFERRED EMBODIMENTS

The present invention enables a primary transaction cardholder to determine the manner in which one or more secondary transaction cardholders utilize an account or accounts associated with the primary transaction cardholder. Thus, for example, the primary transaction cardholder is enabled to limit the types of transactions in which a secondary transaction cardholder can engage, and more particularly to specify the categories of merchants with which the secondary cardholder(s) are permitted and/or are not permitted to engage in business transactions. Thus, the primary cardholder is enabled to specify certain merchant categories, such as adult entertainment, violent gaming, gambling, etc., and thereby ensure that attempts by the secondary cardholder(s) to transact business with merchants associated with the selected categories will be refused authorization.

Exemplary methods according to specific embodiments of the invention can be carried out via a network such as the World Wide Web or the Internet, using a browser such as Netscape or Internet Explorer. Initially, a primary transaction cardholder accesses an interface, such as a web site, which the issuer maintains, and using an appropriate application provided by the issuer, requests a listing of all secondary transaction cardholders associated with an account of the primary transaction cardholder, and if desired, a listing of all account information pertaining to the primary and/or secondary transaction cards associated with the account. If no secondary transaction cardholders are yet associated with the account of the primary transaction cardholder, the primary transaction cardholder can request that the issuer provide one or more persons with secondary transaction cards, and supply the issuer with appropriate information identifying each such secondary transaction cardholder (e.g., name, address, age, and the like).

After one or more secondary transaction cardholders associated with the account of the primary transaction cardholder have been identified, the primary transaction cardholder next provides the issuer with at least one code to be associated with each secondary transaction cardholder. The codes can identify limits or restrictions on the use of the account, and can be specified in any conventional manner, such as by a sequence of alphanumeric characters within a specified range of lengths. Such a code can be, for example, a password, a merchant category code, a code specifying the days of the week or month on which the secondary transaction card can (or cannot) be used, a weekly or monthly spending limit, etc. In more specific embodiments, the primary transaction cardholder can provide two or more such codes.

In particular embodiments, the primary transaction cardholder can provide a plurality of merchant category codes to be associated with each secondary transaction cardholder. Certain of the merchant category codes can correspond to types of businesses, such as department stores, bookstores, restaurants, etc., with which the secondary transaction cardholder is permitted to conduct transactions, while other of the merchant category codes can correspond to types of business, such as adult entertainment, gambling, the sale of alcoholic beverages, etc., with which the secondary transaction cardholder is prohibited from conducting transactions. In other preferred embodiments, the codes can designate a merchant with which a secondary cardholder is authorized to conduct transactions. If desired, codes for particular merchants within one or more merchant category codes can also be supplied by the primary transaction cardholder, in order, for example, to permit a secondary transaction cardholder to conduct business transactions at one or more specific restaurants but not at others associated with the same merchant category code.

In more specific preferred embodiments, the issuer maintains a database of merchant category codes which the primary transaction cardholder can access (for example, by use of a password supplied by the issuer to the primary transaction cardholder for this purpose) and from which the primary transaction cardholder can select the code(s) to be associated with each secondary transaction cardholder. Such a database can include a description of each merchant category code, to assist the primary transaction cardholder in selecting those merchant categories which are approved (or disapproved) for each secondary transaction cardholder.

Preferably, any of the codes and other account information associated with each secondary transaction cardholder can be modified or supplemented at any time by the primary transaction cardholder in a manner similar to that described above.

After the primary transaction cardholder has selected one or more codes for each secondary transaction cardholder (and preferably immediately upon such selection), a secondary transaction cardholder is enabled to utilize the account with which the secondary transaction card is associated, provided that the secondary transaction cardholder provides to the issuer an appropriate code as specified previously by the primary transaction cardholder. Thus, in specific embodiments, a secondary transaction cardholder wishing to access account information can access a web site or other appropriate interface maintained by the issuer. In particular preferred embodiments, the secondary transaction cardholder is authorized by the issuer to access only a subset of the information associated with the account, and more particularly, is authorized to access only account information pertaining to transactions conducted using the secondary transaction card associated with the password submitted by the secondary transaction cardholder. Such information can include, without limitation, transaction histories, spending limitations (e.g., weekly or monthly), account balances, and the like.

In other specific embodiments, a secondary transaction cardholder desiring to engage in a transaction with a merchant supplies to the issuer, indirectly through the merchant, the merchant category code associated with that particular merchant. In other words, the secondary transaction cardholder presents the secondary transaction card to the merchant. The merchant in turn submits the transaction to the issuer, typically by electronic means, for approval. The issuer, having received the proposed transaction from the merchant, determines the merchant category code with which the merchant is associated. The issuer then determines whether the code matches a code provided by the primary transaction cardholder. If the code corresponds to a code for which the secondary transaction cardholder is authorized to utilize the account, the issuer approves the transaction. Alternatively, if the code corresponds to a code for which the secondary transaction cardholder is not authorized to utilize the account, the issuer refuses to authorize the transaction.

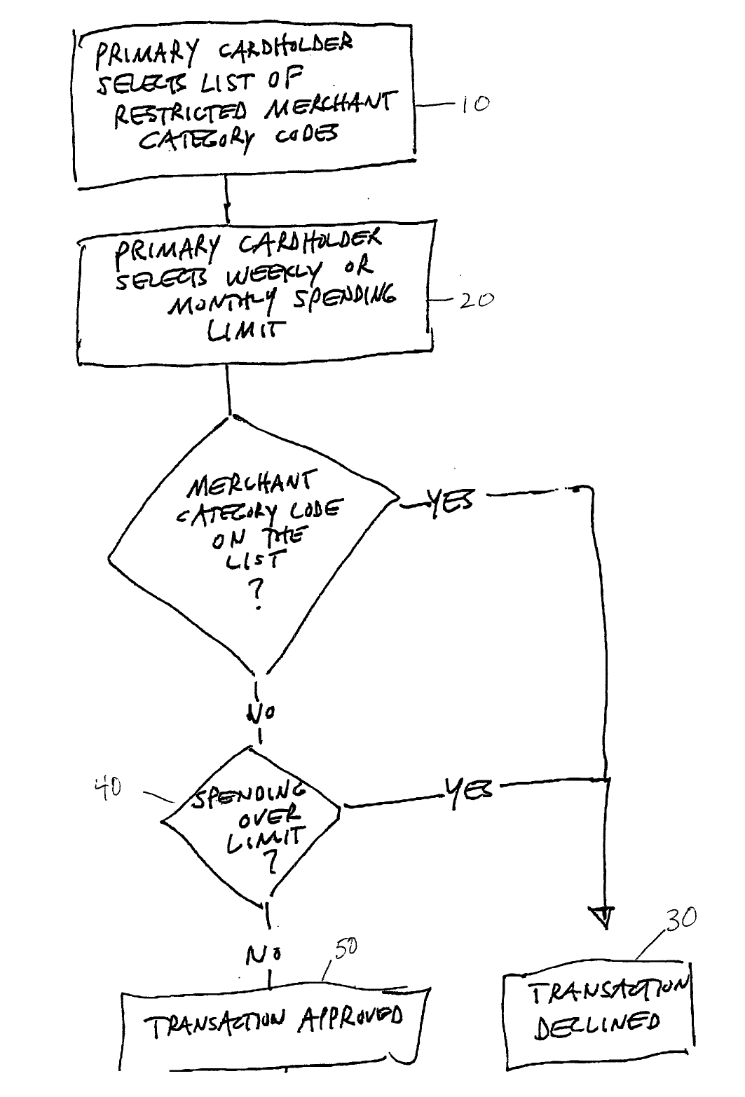

An exemplary embodiment of the inventive method is illustrated in the flowchart of FIG. 1. In this embodiment, one primary transaction cardholder (denoted PTC) and one secondary transaction cardholder (designated STC) are assumed. Once the primary transaction cardholder has accessed the issuer's web site, the site provides the options of specifying a password and/or one or more merchant category codes to be associated with the secondary transaction cardholder. The primary cardholder selects at least one code, for example, a merchant category code, and provides the code information to the issuer 10. Further, the primary cardholder selects other codes which can restrict or limit the account use, such as, for example, a weekly or monthly spending limit 20. This information is also provided to the issuer. Once the associated codes are selected, the secondary transaction cardholder is then enabled to attempt to access account information and/or to engage in transactions with merchants.

When the secondary cardholder attempts to conduct a transaction, the secondary cardholder's information is compared to the merchant code provided at the time of the transaction. If the merchant's code is associated with the cardholder, the transaction is denied 30. If the merchant's code is not associated with the cardholder, the amount of the transaction is reviewed 40. The issuer, in these embodiments, maintains a running count of the amount spent by each secondary transaction cardholder during a time interval determined by the primary transaction cardholder (e.g., a week, a month, etc.). The issuer then adds the amount of the desired transaction to the running count and compares the total with the spending limit set by the primary transaction cardholder. If the total is less than or equal to the spending limit, the transaction is approved 50. However, if the total exceeds the spending limit, the issuer refuses to authorize the transaction 30.

As noted above, according to preferred embodiments, the code(s) provided by the primary transaction cardholder, such as the merchant category code(s), are effective immediately. Thus, for example, in the event that the primary transaction cardholder makes an error in merchant category code selection, the secondary transaction cardholder can contact the primary transaction cardholder (such as by telephone from the merchant's location). At that point, the primary transaction cardholder can contact the issuer, for example by logging on to a web site belonging to the issuer using a personal computer and a browser, and modify merchant category code(s) associated with the secondary transaction card. The secondary transaction cardholder can then repeat the transaction, which will then be approved if other account criteria would otherwise qualify the transaction for approval. Similarly, spending limits for secondary transaction cardholders can also be modified by the primary transaction cardholder.

The following types of information, according to various preferred embodiments, are beneficially provided by the issuer to the primary transaction cardholder to assist the primary transaction cardholder in selecting appropriate codes (i.e., passwords, merchant category codes, spending limits and the like):

a) a database of merchant data including a merchant category code which is selected by the issuer to describe the nature of the transactions engaged in by the merchant;

b) a database of merchant category codes, category code descriptions, and indicators for those adult business prohibited for secondary cardholders under the age of 18 or under the age of 21;

c) a database of accounts, the primary and secondary transaction cards associated with the accounts, and passwords needed for the primary transaction cardholder to access transaction card and account data;

d) a database of merchant category codes designated as restricted or limited by the primary transaction cardholder for specific secondary transaction cards;

e) a database of transactions engaged by primary and secondary transaction cardholders of the account;

f) a database of available credit for the week or month available to secondary transaction cardholders, wherein each transaction decrements the amount available for the week or month, and the amount is refreshed at the end of the week or month.

Databases including other types of information can also be provided by the issuer if desired.

Preferably, the issuer operates a data processing facility, such as a central computer, that includes an application which assures that secondary transaction cards are not used by merchants having the category code(s) disallowed by the primary transaction cardholder, and/or that the usage of the secondary transaction cards is limited to the specific merchant category codes selected by the primary transaction cardholder. Merchants who submit for authorization transactions designated as excluded by the primary cardholder (for example, transactions with merchants in the adult entertainment industry by underage secondary transaction cardholders) thus will receive a refused (declined) return code when the transaction is submitted for authorization approval to the issuer.

Also preferably, an application is provided by the issuer which is accessible by a primary transaction cardholder to access all information related to the account(s) of the primary transaction cardholder, including weekly or monthly spending limits which can be specified for secondary transaction cards, options for canceling or adding secondary transaction cards, address information for the account and/or all associated transaction cards, and passwords for the primary transaction card and for any or all secondary transaction cards.

What we claimed is:

1. A method for controlling utilization of an account having associated therewith an issuer, a primary transaction cardholder and a secondary transaction cardholder, the method comprising the steps of:
a) associating with the secondary transaction cardholder at least one code, wherein the code identifies a condition for account use; and
b) authorizing utilization of the account wherein the utilization of the account is in accordance with the condition set by the code.

2. The method of claim 1 wherein in step a) the code is a merchant category code.

3. The method of claim 2 wherein in step b) the secondary transaction cardholder is authorized to complete a transaction with a merchant when the merchant is associated with the code by the issuer.

4. The method of claim 4 wherein in step b) the secondary transaction cardholder is authorized to access information pertaining only to transactions made using a transaction card issued to the secondary transaction cardholder.

5. The method of claim 1 wherein in step a) the code is selected from a database provided to the primary transaction cardholder by the issuer.

6. The method of claim 1 wherein the code is a spending limit.
